(19) United States
(12) Patent Application Publication
(10) Pub. No.: US 2022/0348271 A1
(43) Pub. Date: Nov. 3, 2022

(54) DEFLECTOR DEVICE FOR A MOTOR VEHICLE WHEEL, AND VEHICLE COMPRISING SUCH A DEVICE

(71) Applicant: Valeo Systemes Thermiques, Le Mesnil-Saint-Denis Cedex (FR)

(72) Inventors: Laura Marion, Le Mesnil Saint Denis Cedex (FR); Frédéric Vacca, Le Mesnil Saint-Denis Cedex (FR)

(73) Assignee: Valeo Systemes Thermiques, Le Mesnil-Saint-Denis Cedex (FR)

(21) Appl. No.: 17/293,152

(22) PCT Filed: Oct. 28, 2019
(86) PCT No.: PCT/FR2019/052563

§ 371 Date: May 12, 2021

(30) Foreign Application Priority Data
Nov. 14, 2018 (FR) 1860489

(51) Int. Cl. B62D 35/02; B62D 37/02

(52) U.S. Cl. CPC B62D 35/02; B62D 37/02

(57) ABSTRACT

Deflector device (7) for a motor vehicle wheel (3), comprising at least one aerodynamic region (4, 400, 401) designed to be exposed to an external air flow (IO), the device (7) further comprising an articulated mechanism (21) for moving the at least one aerodynamic region (4, 400, 401) so as to allow the deflector (7) to move from the retracted position to the deployed position, said articulated mechanism (21) comprising a drive member (22), and said articulated mechanism (21) being arranged to move the drive member (22) translationally when the deflector device (7) moves from the retracted position to the deployed position, the deflector device (7) comprising an actuator (19) configured to control the articulated mechanism (21) so as to allow the aerodynamic regions of the deflector to move relative to each other, said deflector device (7) further comprising a security device (50) configured to return said deflector device (7) to the retracted position without intervention by the actuator (19).

The invention relates to a deflector device for a motor vehicle wheel, said deflector device also comprising a safety device. The invention also relates to a vehicle provided with such a deflector device.

A constant preoccupation in the automotive sector is that of fuel consumption and the ecological impact of the vehicle in particular due to its emissions of greenhouse gases such as CO₂ or due to toxic gases such as NOx, for example. In order to reduce fuel consumption, automobile manufacturers have been attempting to make propulsion engines more efficient and to reduce the consumption of the equipment of the vehicle.

An important factor in the consumption of a vehicle is determined by the wind loading or the aerodynamics of the vehicle.

Specifically, the aerodynamics of a motor vehicle is an important characteristic since it particularly influences the fuel consumption (and therefore pollution) and also the performance, in particular acceleration performance, of said vehicle.

In particular, drag or aerodynamic resistance to forward travel plays a decisive role, in particular at higher speeds, since drag varies as a function of the square of the speed of movement of the vehicle.

It is known to place a fixed deflector device in front of a motor vehicle wheel. Such a fixed deflector, which can take the form of a skirt, makes it possible to reduce the turbulence in the wheel housing.

However, such a fixed deflector risks being damaged when crossing obstacles (sidewalk, speed-reducing device of the speed hump type, etc.).

In order to solve this problem, deflector devices provided with an actuator have been envisaged and described in various documents, in particular FR1561093 and FR1562111, the actuator being arranged so that it deploys and retracts the deflector in front of the wheel of a motor vehicle.

The control unit of the vehicle for example orders the deployment of the deflector device when the vehicle reaches a speed substantially greater than 80 km/h, whereas it orders the retraction thereof at a speed substantially less than 80 km/h.

However, in the event of a fault, in particular in the event of the actuator failing, the deflector device can be locked in the deployed position, which increases the risk of collisions between the deflector device and the external environment (speed-reducing devices of the speed hump type, obstacles in the road, sidewalk, etc.).

The present invention aims to propose a solution to the aforementioned problem.

The present invention relates to a deflector device for a motor vehicle wheel comprising at least one aerodynamic region, arranged so that it is exposed to a flow of external air, the device also comprising an articulated mechanism for moving said at least one aerodynamic region, so as to allow the deflector to pass from the retracted position to the deployed position, this articulated mechanism having a drive member, and this articulated mechanism being arranged so that it moves the drive member in a translational movement when the deflector device passes from the retracted position to the deployed position, said deflector device comprising an actuator, configured to control the articulated mechanism, so as to allow the movement of the aerodynamic regions of the deflector with respect to each other, said deflector device also comprising a safety device configured to return said deflector device to the retracted position without the intervention of the actuator.

The deflector device according to the invention can have one or more of the features described below, taken alone or in combination:
the safety device is configured to disconnect said actuator from the articulated mechanism in the event of a fault, such as the failure of the actuator or emergency braking,
a control unit of the vehicle is configured to activate said safety device,
the articulated mechanism has a platform arranged so that it is fixed with respect to the vehicle, said platform being mounted on the vehicle, and the drive member moving in a translational movement with respect to said platform,
the drive member and the platform of the articulated mechanism are connected by means of at least two rods moving with respect to each other,
the drive member is a slider provided with at least one movement rail,
each of the rods is provided with a toothed wheel at the end thereof connected to the platform of the articulated mechanism, said toothed wheels meshing together, and each of the rods comprises at least one sheath at the end thereof connected to the slider of the articulated mechanism, said sheath cooperating with the movement rail of the slider, so that one of the rods, when it is driven by the actuator, transmits its movement to the adjacent rod,
the safety device comprises at least one member made of a shape memory material, configured to be supplied with electric power so as to deform between a first state and a second state in order to disconnect the actuator from the articulated mechanism, in the event of a fault, such as the failure of the actuator or emergency braking,
the safety device has a track holder having at least two conductive tracks for supplying said at least one member made of shape memory material with electric power, and said at least one member made of shape memory material has at least two contactor elements configured to each be arranged in electrical contact with an associated conductive track, at least when said at least one member made of shape memory material is in the first state. The electric power supply is therefore ensured by the contact between the contactor elements and the conductive tracks,
said at least one member made of shape memory material is mounted so as to be rotatable about a driving axis with respect to the track holder. A turning contactor for supplying electric power to the member made of shape memory material is thus realized,
said at least one member made of shape memory material is configured to pass from a compressed rest state to an expanded state when it is supplied with power,
the holder has an annular overall shape that is centered on the driving axis and has a predefined radial footprint,
said at least two contactor elements are arranged so that they have a radial footprint smaller than or around the same as the radial footprint of the track holder,
the contactor elements are realized by sliding contacts,
the contactor elements are each arranged in electrical contact with an associated conductive track, regardless of the state of said at least one member made of shape memory material,
the contactor elements are each arranged in electrical contact with an associated conductive track, regardless of the angular position of said at least one member made of shape memory material with respect to the track holder,
the contactor elements are at least partially flexible,
the conductive tracks are on a face of the track holder that is arranged facing said at least one member made of shape memory material,
the track holder has at least one electrical connector for supplying power to the conductive tracks, said electrical connector being arranged on the opposite side from the conductive tracks,
said device comprises a drive shaft configured to be arranged so as to transmit a movement from the actuator to said articulated mechanism,
said drive shaft has a cavity for receiving said at least one member made of shape memory material,
said safety device comprises a transmission element that is rotationally coupled to the drive shaft and mounted so as to be movable between an engaged position, in which it is rotationally coupled to the driver, and a disengaged position, in which it is decoupled from the driver,
said at least one member made of shape memory material is configured to urge the transmission element toward the disengaged position if the actuator fails,
the drive shaft is configured to be driven in rotation about a driving axis by the actuator,
the transmission element is axially movable between the engaged and disengaged positions,
the driver has a housing in which the drive shaft and the transmission element are at least partially arranged,
the track holder is fitted to the driver so as to close the housing,
the transmission element is arranged around an end portion of the drive shaft having the cavity for receiving said at least one member made of shape memory material,
the transmission element has a main body arranged around the end portion of the drive shaft and an end wall arranged facing the end portion of the drive shaft,
the end wall is formed on a closure cap fitted to the main body,
the end wall of the transmission element has at least two openings for the contactor elements of said at least one member made of shape memory material to pass through,
said at least one member made of shape memory material comprises at least one spring,
said device has an elastic return element arranged so as to urge the transmission element toward the engaged position, such that said at least one member made of shape memory material is configured to urge the transmission element toward the disengaged position counter to the force exerted by the elastic return element.

The invention also relates to a motor vehicle comprising a deflector device as described above.

Further features and advantages of the invention will become more clearly apparent on reading the following description, which is given by way of non-limiting illustrative example, and from the appended drawings, in which:

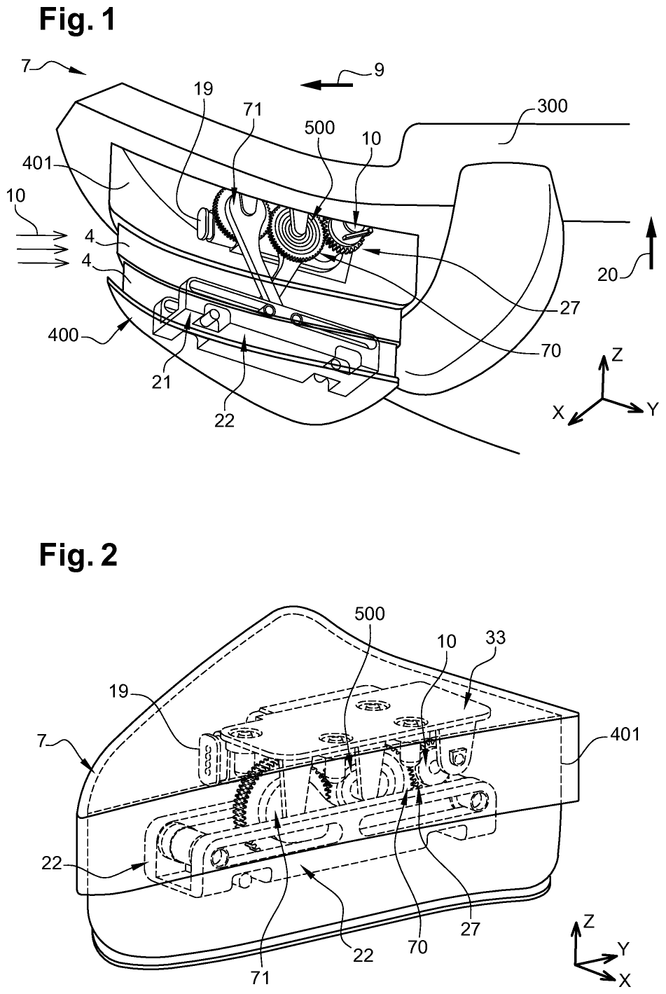

FIG. 1 is a diagram of the deflector device in the deployed position, comprising an articulated mechanism for moving the aerodynamic regions of said deflector device according to a particular embodiment of the invention, together with a safety device,

FIG. 2 is a diagram of the deflector device in the retracted position, comprising an articulated mechanism for moving the aerodynamic regions of said deflector device according to a particular embodiment of the invention, together with a safety device,

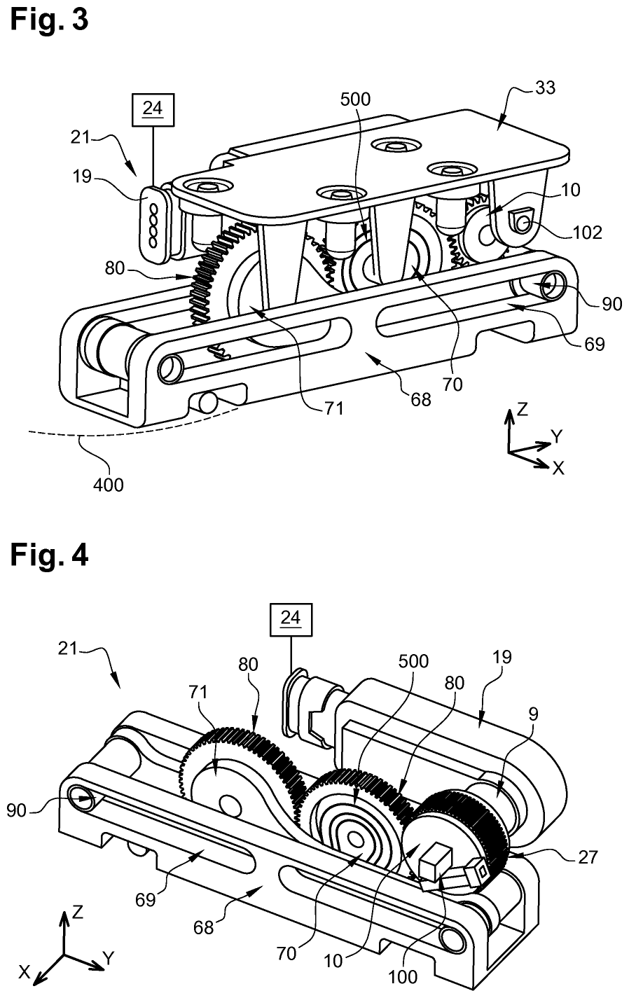

FIGS. 3 and 4 show a side perspective view of the articulated mechanism for moving the aerodynamic regions according to a particular embodiment of the invention, when the deflector device is in the retracted position,

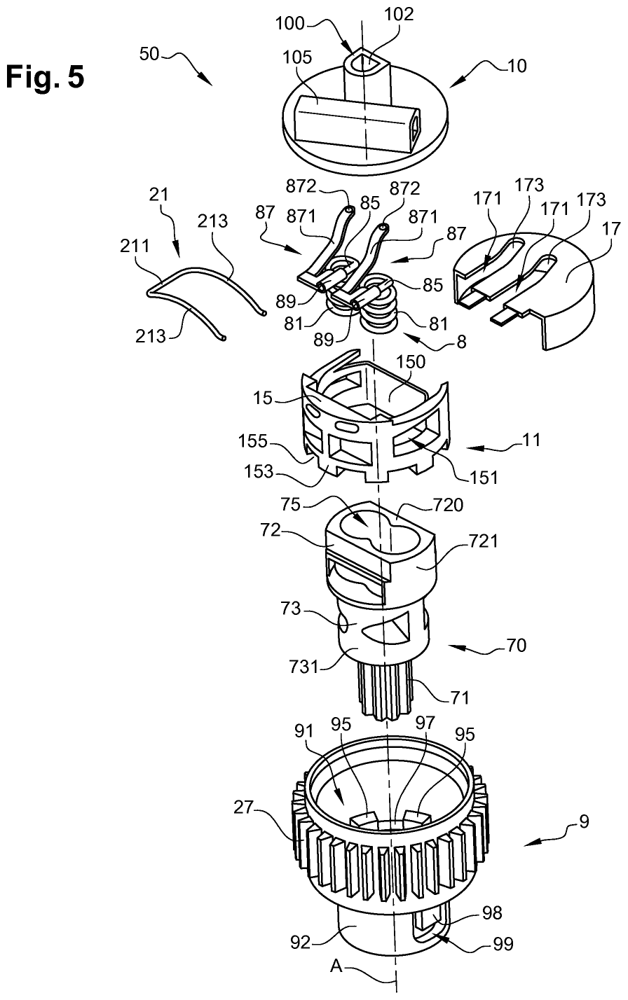

FIG. 5 is an exploded view of an engagement and disengagement mechanism of the safety device of the deflector device in FIGS. 1 and 2,

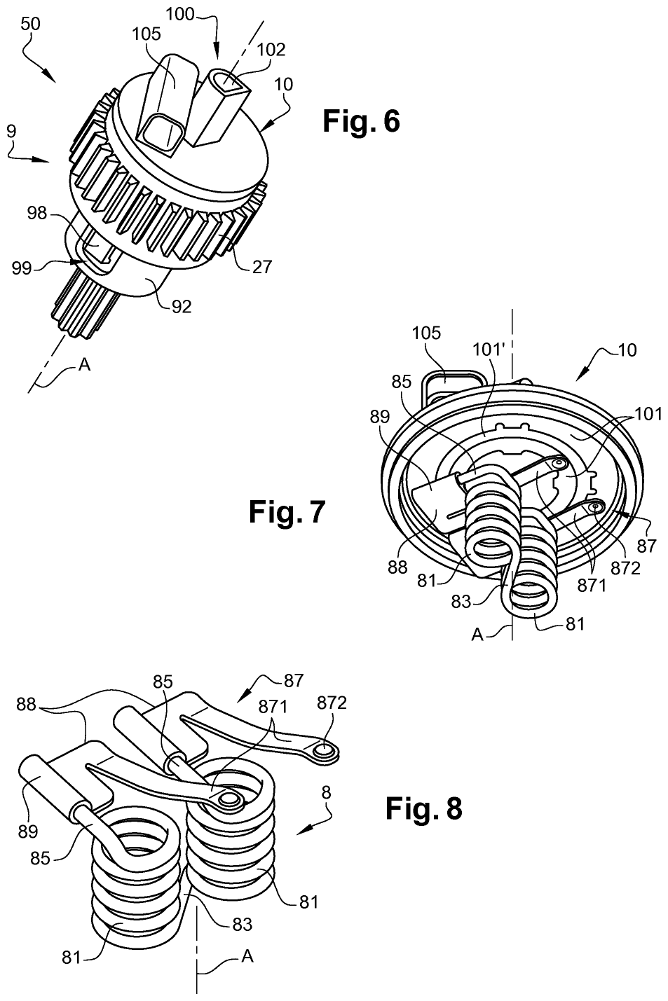

FIG. 6 is a view in the assembled state of the engagement and disengagement mechanism in FIG. 5,

FIG. 7 shows the member made of shape memory material in FIG. 8 connected to an associated track holder,

FIG. 8 shows in detail the member made of shape memory material in FIG. 5.

The following embodiments are examples. Although the description refers to one or more embodiments, this does not necessarily mean that each reference relates to the same embodiment, or that the features apply only to one embodiment. Individual features of various embodiments can also be combined or interchanged in order to create other embodiments.

The horizontal plane is denoted by a reference frame (X, Y) and the vertical direction by the direction Z, the three directions forming a trihedron (X, Y, Z). These axes can correspond to the designation of the axes in a motor vehicle, that is, by convention, in a vehicle, the X axis corresponds to the longitudinal axis of the vehicle, the Y axis corresponds to the transverse axis of the vehicle and the Z axis to the vertical axis over the height of the vehicle.

In the present description, the terms vertical/horizontal or top/bottom refer to the positioning of the elements in the figures, which corresponds to the positioning of the elements in the mounted state in the motor vehicle.

FIG. 1 shows a deflector device 7 comprising four aerodynamic regions (401, 4, 4, 400) for a motor vehicle wheel.

In the diagram of FIG. 1, the vehicle moves in the direction of the arrow 9, so that an air flow 10 strikes the motor vehicle.

The deflector device 7 comprises four aerodynamic regions (401, 4, 4, 400) arranged so that they are exposed to the air flow 10. These aerodynamic regions are arranged so that they move with respect to each other when the deflector device 7 passes from a deployed position (FIG. 1) to a retracted position (FIG. 2). In other words, the deflector device 7 is telescopic with elements that fit into and slide in one another.

More particularly, the aerodynamic region 401 is configured to be fastened to the chassis 300 of the vehicle, upstream of a wheel (not shown on the diagram), and in particular at the level of a wheel housing. Said aerodynamic region is fastened to the chassis 300 of the vehicle by screwing or clips, for example, or by any other fastening means.

The shape of the aerodynamic regions does not limit the present invention and can be freely adapted.

In the deployed position shown in FIG. 1, the deflector device 7 is placed in the path of the air flow 10 upstream of the wheel of the vehicle. The air flow 10 is thus deflected so as not to be able to sweep into the wheel housing. When the deflector device 7 is in the retracted position as shown in FIG. 2, the footprint of such a device is at its minimum. As the aerodynamic regions are increasing in size, they are all fitted inside each other when the deflector device 7 is in the retracted position (FIG. 2). The deflector device 7 does not therefore substantially obstruct the air flow 10 striking the wheel.

When the deflector device 7 is in the deployed position (FIG. 1), the footprint of such a device is at its maximum. The total height H_{A} of the deployed aerodynamic regions is substantially greater than the total height H_{B} of the aerodynamic regions when the deflector device 7 is in the retracted position (comparison illustrated in FIGS. 1 and 2).

When the deflector device 7 passes from the deployed position (FIG. 1) to the retracted position (FIG. 2), the aerodynamic regions are arranged so that they move parallel to each other along a retraction axis 20, which is substantially parallel to the Z axis.

In order to be able to effect the movement between the deployed position (FIG. 1) and the retracted position (FIG. 2), the deflector device 7 also comprises an articulated mechanism 21 for moving the aerodynamic regions. FIGS. 1 and 2 show a cutaway view of the articulated mechanism 21 inside the deflector device 7, when the deflector device 7 is in the deployed position (FIG. 1) and when the deflector device 7 is in the retracted position (FIG. 2). FIGS. 3 and 4 show this articulated mechanism 21 in greater detail when the deflector device 7 is in the retracted position as in the example of FIG. 2.

The articulated mechanism 21 has a drive member 22, for example a slider, and is arranged so that it moves the drive member 22 in a translational movement (along the Z axis when the deflector device 7 passes from the retracted position to the deployed position). The drive member 22 is therefore rigidly connected to the aerodynamic region 400 of the deflector device 7, that is, the aerodynamic region that is furthest from the chassis of the motor vehicle (i.e. the aerodynamic region that is closest to the road once the deflector device has been deployed).

The articulated mechanism 21 is configured to be controlled by an actuator 19. The articulated mechanism 21 is therefore connected to the actuator 19. The actuator 19 is connected to a platform 33 of the articulated mechanism 21.

The actuator 19 is configured to move the aerodynamic regions parallel to each other along the retraction axis 20, when the deflector device passes from the deployed position to the retracted position (and vice versa).

The actuator 19 can be an electric actuator, for example an electric motor.

The articulated mechanism 21 has a platform 33 arranged so that it is fixed with respect to the vehicle. The platform 33 can be mounted on the chassis 300 of the vehicle. The drive member 22 moves in a translational movement (along an axis substantially parallel to the Z axis) with respect to the platform 33.

According to a particular embodiment of the invention illustrated in FIGS. 1 to 4, the drive member 22 and the platform 33 of the articulated mechanism 21 are connected by means of two rods (70, 71) that move with respect to each other. The rods (70, 71) are for example stem-shaped.

According to the embodiment described in FIGS. 1 to 4, the drive member 22 is a slider provided with a movement rail 69.

Each of the rods (70, 71) is provided with a toothed wheel 80 at the end thereof connected to the platform 33 of the articulated mechanism 21, the toothed wheels 80 meshing together. It is visible in FIGS. 3 and 4 that each of the rods (70, 71) comprises at least one sleeve 90 at the end thereof connected to the slider 22 of the articulated mechanism 21. The sleeve 90 cooperates with the movement rail 69 of the slider 22, so that the rod 70, when it is driven by means of the actuator 19, transmits its movement to the adjacent rod 71.

FIG. 4 shows the articulated mechanism 21 without its platform 33, so that the gear system can be seen more clearly.

According to FIG. 4, the actuator 19 comprises an output member in indirect engagement with the platform 33 of the articulated mechanism 21. The output member of the actuator 19 has a driver 9, or drive shaft, provided with a toothed main body 27 meshing with the toothed wheel 80 of the rod 70.

The movements of the articulated mechanism 21 during normal operation without failure of the actuator 19 will now be described in greater detail. The driver 9 drives the rod 70 in translation with respect to the retraction axis 20 by means of the toothed main body 27. The movement of the rod 70 is transmitted to the adjacent rod 71 by means of the pinions 80 meshing together, while the sleeves 90 cooperate with the movement rail 69 of the slider 22. The slider 22 then moves in a translational movement with respect to the platform 33 of the articulated mechanism 21, parallel to the retraction axis 20.

As the aerodynamic region 400 is connected to the drive member 22 of the articulated mechanism 21, the translational movement is transmitted to all of the aerodynamic regions.

Furthermore, the deflector device 7 can also comprise a control unit 24 electrically connected to the actuator 19 and configured to activate or start the actuator 19 when the deflector device 7 must pass from a retracted position to a deployed position or vice versa.

The control unit 24 comprises, for example, an electronic circuit such as a microprocessor or a microcontroller receiving speed information from a speed sensor and ordering the deployment or the retraction of the deflector device 7.

To overcome any malfunction of the actuator 19, the deflector device 7 also comprises a safety device 50 (visible in detail in FIG. 5) configured to return said deflector device 7 to its retracted position without the intervention of the actuator 19. Such a safety device 50 prevents the deflector device from being damaged when crossing obstacles (sidewalk, speed-reducing devices of the speed hump type, etc.) in the road.

The safety device 50 is configured to disconnect said actuator 19 from the articulated mechanism 21 in the event of a fault, such as the failure of the actuator 19 or emergency braking of the vehicle.

In particular, the safety device 50 has at least one member 8 made of shape memory material (visible more particularly in FIG. 5). The member 8 made of shape memory material is configured to be supplied with electric power so as to deform between a first state and a second state. This change of state can take place if the actuator 19 fails. The member 8 made of shape memory material is therefore able to be connected to an electric power source (not shown).

The member 8 made of shape memory material is configured to change state if the actuator 19 fails. This member 8 made of shape memory material is arranged so as to disconnect the actuator 19 from the articulated mechanism 21, when it passes from one state to another, in particular from the first state to the second.

The member 8 made of shape memory material can pass from a compressed or shrunk state to an expanded state and vice versa. When it is compressed, the member 8 made of shape memory material can expand or lengthen by a predefined distance. By way of non-limiting example, a member 8 made of shape memory material having a shrinkage coefficient of around 2% to 8%, preferably around 4%, can be provided.

If the actuator 19 fails only temporarily, when the failure ceases, the member 8 made of shape memory material can return to the starting or rest state, for example to the compressed state.

Provision can be made, for example, for the member 8 made of shape memory material, when it is supplied with power, to be in its compressed form and, when it is no longer supplied with power, to return to its expanded form in the rest state and to regain its original length. Or, by contrast, provision can be made for the member 8 made of shape memory material, when it is supplied with power, to be in its expanded form and, when it is no longer supplied with power, to return to its compressed form in the rest state. This is the preferred embodiment variant.

The member 8 made of shape memory material can comprise at least one spring.

In particular, as illustrated in FIGS. 5 and 6, the member 8 made of shape memory material can comprise two springs 81, for example coil springs, that meet at one end. In other words, the two springs 81 have a common end. It is also possible to speak of a double winding 81 for forming the member 8 made of shape memory material.

The design of the member 8 made of shape memory material is not limited to this particular example. Any other form of the member 8 made of shape memory material can be envisaged. By way of example, a wire made of shape memory material can be provided, which can be substantially straight or have a curved or spiral shape at least in one portion.

The safety device 50 additionally has one or more electrical connection means for connecting the member 8 made of shape memory material to the electric power source (not shown in the figures).

According to the embodiment illustrated in FIG. 5, the safety device 50 has a track holder 10. The track holder 10 is mounted in the safety device 50 in a rotationally retained manner. The track holder 10 can be mounted on the platform 33, so as to be prevented from rotating. In a complementary manner, the cover 10 can have an indexing member 100 with at least one flat 102. The indexing member 100 is configured to be received in a housing of complementary shape on the platform 33, allowing in particular the track holder 10 to move in translation with respect to the platform 33 for assembly, and preventing the track holder 10 from being able to rotate with respect to the platform 33.

With reference to FIG. 7, the holder 10 has at least two conductive tracks 101 for supplying electric power to the member 8 made of shape memory material.

In the example illustrated, two conductive tracks 101 are provided, one track for the positive pole and one track for the negative pole. By way of example, the conductive tracks 101 can, for example, be supplied with electric power if the actuator 19 fails. When the actuator 19 is disconnected from the articulated mechanism 21, the electric power supply to the conductive tracks 101 can be switched off.

The conductive tracks 101 are made for example of brass. The conductive tracks 101 are on a face of the track holder 10 that is arranged facing the member 8 made of shape memory material in the assembled state of the safety device 50. By way of non-limiting example, the conductive tracks 101 can be overmolded on the track holder 10. The conductive tracks 101 can be arranged concentrically with a central axis.

According to FIG. 5 or 7, the member 8 made of shape memory material has at least two contactor elements 87 that are each configured to come into electrical contact with an associated conductive track 101 at least under certain conditions, for example at least when the member 8 made of shape memory material is in the first state, in the rest state in this example.

The contactor elements are for example sliding contacts 87.

According to the particular example illustrated with a member 8 made of shape memory material realized by two springs or two windings 81 connected by a common end 83, a sliding contact 87 is connected to the opposite end 85 of each spring or winding 81 from the common end 83. The sliding contact 87 is connected at least electrically to the end 85 of the spring 81.

To this end, the safety device 50 has a connection interface between the member 8 made of shape memory material and the sliding contact(s) 87. In particular, a plate 88 can be provided for each sliding contact 87, the sliding contact 87 extending therefrom. The plate 88 is for example flat or substantially flat.

Each plate 88 can have a sleeve 89 intended to receive the end 85 of the corresponding spring 81. The shape of the sleeve 89 is adapted to the shape of the end 85 of the spring 81. In a variant, any other shape can be envisaged for receiving an end of the member 8 made of shape memory material.

The sliding contacts 87 can each have a tongue 871 that extends from the plate 88 and terminates with an end 872. The tongues 871 are configured for example to extend along an inclined direction with respect to the general plane defined by the plate 88, when the member 8 made of shape memory material is in the rest state, that is, with the springs 81 compressed.

The sliding contacts 87 are able to move with respect to the track holder 10. In other words, the sliding contacts 87 can pass from one position to another with respect to the track holder 10 when the member 8 made of shape memory material changes state.

In particular, the sliding contacts 87 are at least partially flexible. More specifically, at least the tongues 871 are flexible.

Referring more particularly to FIG. 7, the member 8 made of shape memory material and the track holder 10 can be arranged such that the ends 872 of the sliding contacts 87 are in electrical contact with the conductive tracks 101.

When the member 8 made of shape memory material changes state, that is, in the example described, when the springs 81 pass from a compressed state to an expanded state, the plates 88 move toward the track holder 10, and by contrast, when the springs 81 are compressed again, the plates 88 move away from the track holder 10. In other words, the inclination angle of the tongues 871 with respect to the plates 88 decreases when the springs 81 expand, thus moving toward the track holder 10, and, by contrast, increases when the springs 81 are compressed again, moving away from the track holder 10.

The sliding contacts 87 thus remain in contact with the conductive tracks 101 in order to ensure proper electrical contact therewith, regardless of the axial position of the member 8 made of shape memory material, in particular of the springs 81, with respect to the track holder 10.

In addition, as is described in detail below, the member 8 made of shape memory material is mounted in an assembly that is rotatable, while the track holder remains rotationally retained. As a result, the sliding contacts 87 turn about the driving axis A following the complementary circular shape of the conductive tracks 101. A turning contactor for supplying power to the member 8 made of shape memory material is thus formed.

At least when the member 8 made of shape memory material is in the first state, in the rest state in this example, the sliding contacts 87 can be in contact with the conductive tracks 101, regardless of the angular position of the member 8 made of shape memory material with respect to the track holder 10. Thus, when the member 8 made of shape memory material is supplied with power, if the actuator 19 fails for example, electrical contact is ensured between the sliding contacts 87 and the conductive tracks 101, regardless of the angular position of the member 8 made of shape memory material.

Thus, according to one embodiment, when the member 8 made of shape memory material is not supplied with power, it is in its compressed form and the sliding contacts 87 are in contact with the conductive tracks 101. If the actuator 19 fails, the member 8 made of shape memory material is supplied with power and deforms between the first state and the second state, that is, expands in the example described. On expanding, the member 8 made of shape memory material participates in disconnecting the actuator 19 from the articulated mechanism 21. The plates 88 move toward the track holder 10. The expansion of the member made of shape memory material continues, pressing the sliding contacts 87 against the track holder 10. At the end of travel of the member 8 made of shape memory material, at least one sliding contact 87 or both sliding contacts 87, more specifically the ends 872 thereof, are moved so as to come away from the tracks 101. In particular, the ends 872 are then located in the space between the tracks 101, that is, on the non-conductive track 101′. The contactor elements 87 are then in mechanical contact with the non-conductive intermediate track 101′ and without electrical contact (this configuration is not visible in FIG. 7).

The sliding contacts 87 coming away from the conductive tracks 101 then stops the electric power supply to the member 8 made of shape memory material. This makes it possible to produce an additional safety function. On cooling, the member 8 made of shape memory material then tends to return to the rest state, that is, to return to its compressed form.

In addition, when the actuator 19 is disconnected from the articulated mechanism, the tracks 101 are no longer supplied with power. Thus, when the member 8 made of shape memory material is compressed such that the sliding contacts 87 are again in contact with an associated conductive track 101, since the electric power supply has been stopped, the member 8 made of shape memory material can return to the rest state, that is, compressed in the example described.

Furthermore, the track holder 10 can also carry at least one electrical connector 105. The electrical connector 105 is provided on the opposite side from the conductive tracks 101. It is for example overmolded on the track holder 10. The electrical connector 105 is intended to be connected to the electric power source (not shown) so as to make it possible to supply power to the conductive tracks 101, for example when a complementary electrical connector (not shown) is inserted into the electrical connector 105.

The cooperation of the member 8 made of shape memory material with the other elements of the safety device 50 is described in more detail below.

The safety device 50 can also have a drive shaft 70 (visible in FIG. 5), which is arranged so as to transmit a movement from the actuator 19 to the articulated mechanism 21.

The safety device 50 also has in this example a driver 9 provided with a toothed main body 27 meshing with the toothed wheel 80 of the rod 70, and a transmission element 11 that can be rotatably coupled to or disconnected from the driver 9. Disconnection occurs if the actuator 19 fails under the action of the member 8 made of shape memory material.

As regards the drive shaft 70, it is configured to be driven by the actuator 19. The drive shaft 70 can be driven in rotation about the driving axis A.

This drive shaft 70 can have at least one means for driving the transmission element 11 of the safety device 50 in rotation.

The drive shaft 70 comprises for example a first part 71 configured to be driven by the actuator 19 (not visible in FIG. 5) and a second part 72 configured to cooperate with the transmission element 11.

The first 71 and second 72 parts extend for example longitudinally along the driving axis A.

The section of the first part 71 can have, in a non-limiting manner, an overall star shape.

According to the embodiment described, the second part 72 is configured to be received in the transmission element 11.

The second part 72 is configured to drive the transmission element 11 in rotation. In other words, the second part 72 of the drive shaft 70 has the means for driving the transmission element 11 in rotation. The second part 72 can have, in a non-limiting manner, an elongate overall shape, such as an oblong overall shape. The second part 72 is configured to guide the movement of the transmission element 11, as will be described below.

In addition, this second part 72 can have, on its external contour, a peripheral groove 721 (more clearly visible in FIG. 5).

The drive shaft 70 additionally comprises a joining part 73 between the first 71 and second 72 parts of the drive shaft 70. This joining part 73 is shaped so that it can be received in the driver 9. This joining part 73 can act as a surface for guiding the rotation of the driver 9.

Moreover, the drive shaft 70 has at least one element 731 for preventing the driver 9 from moving in translation or axially.

The driver 9 can be prevented from moving in translation by snap-fastening. To this end, with reference to FIG. 5, the drive shaft 70 can have a peripheral groove 731 configured to cooperate with at least one complementary movement preventing element carried by the driver 9. This peripheral groove 731 is for example in the joining part 73. In this example, this groove 731 is closer to the first part 71 than to the second part 72.

Finally, the drive shaft 70 has a cavity 75 for receiving the member 8 made of shape memory material. The cavity 75 is formed in the second part 72 of the drive shaft 70 that is intended to cooperate with the transmission element 11. This cavity 75 has a shape complementary to the shape of the member 8 made of shape memory material. By way of non-limiting example, the cavity 75 has a contour that is substantially “eight”-shaped or peanut-shaped, or kidney-shaped overall. This “eight” shape or peanut shape is suitable for receiving, at least partially, or entirely, the two joined springs 81 described above. The plates 88, the sleeves 89 and the contactor elements 87 at the ends of the springs 81 can extend outside this cavity 75.

Regarding the driver 9, this can be a drive shaft provided with a toothed main body 27. A driver 9 is understood to be any means or member that makes it possible transmit a movement to the rod 70. To this end, the driver 9 is coupled directly to the rod 70 and is also configured to be driven by the actuator 19 by means of the drive shaft 70.

The shape of the driver 9 can be adapted depending on the safety device 50 in which it is installed and on the actuator 19. With reference to FIG. 5, the driver 9 comprises a toothed main body 27 through which the drive shaft 70 is intended to pass. The toothed main body 27 has for example a cylindrical overall shape.

The driver 9 additionally has a portion 92 that extends from the toothed main body 27 on the same side as the actuator 19. This portion 92 has for example a tubular overall shape. The portion 92 extends for example centrally, from a face of the main body 27. The portion 92 has a smaller diameter than the toothed main body 27.

With reference to FIG. 5, the driver 9 has a cavity defining a housing 91 in which the drive shaft 70 and the transmission element 11 are at least partially arranged. This cavity is provided in the toothed main body 27.

As is visible in FIG. 5, the driver 9 has a plurality of teeth 95 alternating with a plurality of recesses 97. This is referred to more generally as toothing. This toothing is provided on the internal surface of the main body 27. More specifically, the toothing is provided so as to cooperate with the transmission element 11 (not visible in this figure) when it is received in the housing 91.

With reference to FIG. 5 or FIG. 6, the driver 9 can additionally have one or more elements for preventing the drive shaft 70 from moving. In this case, it is translational movement along the driving axis A that is prevented. These movement preventing means can be arranged on the portion 92 of the driver 9. The movement preventing means can be realized by blocking tabs 98 configured to cooperate with the groove 731 in the drive shaft 70 (visible in FIG. 5). The blocking tabs 98 end for example in hooks. In this way, the driver 9 and the drive shaft 70 are assembled for example by clip-fastening or snap-fastening. By way of example, the portion 92 can have notches 99 that define the blocking tabs 98.

Finally, the driver 9 is intended to be fitted to the track holder 10 described above, as illustrated in FIG. 6. To this end, the safety device 50 has complementary fastening means, such as clip-fastening or snap-fastening means, carried by the track holder 10 and by the driver 9.

In the assembled state of the safety device 50, the track holder 10 is arranged facing the housing 91. The track holder 10 can be fitted to the driver 9 so as to close the housing 91 on one side, in this case on the opposite side from the first part 71 of the drive shaft 70. The track holder 10 is therefore arranged on the opposite side of the driver 9 from the actuator 19. The track holder 10 can thus form a cover for the driver 9. The track holder 10 can be fitted to the driver 9 by any appropriate fastening means, such as by clip-fastening or snap-fastening.

The transmission element 11 can be realized by a clutch housing. This transmission element 11 is arranged so as to rotationally couple the drive shaft 70 and the driver 9 in normal operation, and to disconnect from the driver 9 if the actuator 19 fails. The expression “normal operation” in this case means a fault-free mode, without any failure of the actuator 19.

For this purpose, the transmission element 11 is mounted so as to be movable between an engaged position and a disengaged position. In this example, the transmission element 11 is mounted so to be movable axially, that is, movable in translation along the driving axis A.

In the engaged position, the transmission element 11 can transmit a movement from the drive shaft 70 to the driver 9. The transmission element 11 is rotationally coupled to the drive shaft 70 and is rotationally coupled to the driver 9, thereby making it possible to couple the driver 9 and the actuator 19 by means of the drive shaft 70. The driver 9 can then drive the rod 70 of the articulated mechanism 21.

In the disengaged position, the transmission element 11 is disconnected from the driver 9. In this example, the transmission element 11 remains rigidly connected to the drive shaft 70 and is decoupled from the driver 9. The transmission element 11 therefore makes it possible to disconnect the actuator 19 from the articulated mechanism 21 by disconnecting from the driver 9.

To this end, the member 8 made of shape memory material is arranged so as to urge the transmission element 11 toward the disengaged position if the actuator 19 fails. More specifically, the member 8 made of shape memory material axially acts on the transmission element 11. In other words, when the actuator 19 is prevented from moving following a failure, the transmission element 11 can, under the effect of the action of the member 8 made of shape memory material, be moved in translation toward the disengaged position, independently of the drive shaft 70.

As long as the member 8 made of shape memory material is compressed, it does not urge the transmission element 11 toward its disengaged position. Thus, the transmission element 11 remains in the engaged position, the transmission element 11 being coupled to the driver 9.

By contrast, in the expanded state, the member 8 made of shape memory material applies an axial stress to the transmission element 11, urging it toward the disengaged position, which causes the disconnection of the transmission element 11 and the driver 9 if the latter were previously rigidly connected to one another, or leaves the transmission element 11 in the disengaged position if the transmission element 11 was already disconnected from the driver 9.

More specifically, regarding the cooperation of the transmission element 11 with the drive shaft 70, the transmission element 11 is positioned around a portion of the drive shaft 70, namely, in this example, around an end portion that corresponds to the second part 72 of the drive shaft 70. This arrangement is realized by cooperation of shapes between the transmission element 11 and the second part 72 of the drive shaft 70.

In addition, the second part 72 of the drive shaft 70, in particular the external surface facing the transmission element 11, is configured to guide the movement, in this example the sliding, of the transmission element 11 about the second part 72 between the engaged and disengaged positions. This is linear guidance.

According to the embodiment illustrated in FIG. 5, the transmission element 11 has a main body 15, which is arranged around the second part 72 of the drive shaft 70.

In particular, the transmission element 11 has a housing 150 configured to receive the second part 72 of the drive shaft 70. In this example, this housing 150 is provided in the main body 15 of the transmission element 11.

The housing 150 has an elongate overall shape complementary to the shape of the second part 72 of the drive shaft 70. The second part 72 of the drive shaft 70 is intended to be arranged in this housing 150 such that the flats 720 are positioned facing the long sides of the housing 150. This allows the drive shaft 70 to slide in the transmission element but prevents it from rotating. This makes it possible to transmit the torque from the actuator 19 to the driver 9 by means of the transmission element 11.

In addition, as illustrated in FIG. 5, the transmission element 11 can have at least one lateral opening 151, in this example two opposite lateral openings 151. The elongate, for example oblong, shape of the second part 72 of the drive shaft 70 makes it possible to orient the arrangement of the latter in the housing 150 of the transmission element, such that the short side of the second part 72 is positioned facing a lateral opening 151 in the transmission element 11. When the transmission element 11 and the drive shaft 70 are assembled, each lateral opening 151 is aligned with the peripheral groove 721 in the drive shaft 70.

Since the second part 72 of the drive shaft 70 having this cavity 75 is surrounded by the main body 15 of the transmission element 11, the member 8 made of shape memory material is at least partially inside the main body 15. As stated above, the springs 81 of the member 8 made of shape memory material are received in the second part 72 of the drive shaft 70 while the plates 88, the sleeves 89 and the contactor elements 87 extend outside this second part 72. In this case, the plates 88 and the sleeves 89 can be arranged in contact with a complementary contact surface provided for this purpose in the main body 15 of the transmission element 11.

The transmission element 11 additionally has an end wall arranged facing the end portion of the drive shaft 70, that is, the second part 72.

As illustrated in FIG. 5, a closure cap 17 for the transmission element 11 can be provided, said cap 17 being fastened to the main body 15. Assembly is effected for example by cooperation of shapes between the main body 15 and the closure cap 17. In this case, the end wall is formed on this closure cap 17.

When the main body 15 and the closure cap 17 are assembled, the plates 88 and the sleeves 89 are positioned between the main body 15 and the closure cap 17. In other words, the arrangement of the closure cap 17 on the main body 15 makes it possible to sandwich the plates 88 and the sleeves 89 between the closure cap 17 and the main body 15.

The end wall, in this case the closure cap 17 of the transmission element 11, has at least two openings 171 for the contactor elements 87 of the member 8 made of shape memory material to pass through. These are longitudinal openings 171 with shapes complementary to the contactor elements 87, in particular the tongues 871, of the member 8 made of shape memory material. These openings 171 can be continued by housings 173. The terminal regions of the contactor elements 87, these terminal regions comprising the ends 872, can fit at least partially in the housings 173 when the springs 81 extend.

Furthermore, referring again to FIG. 5, the safety device 50 also has at least one elastic return element 21.

The elastic return element 21 is arranged so as to exert a return force urging the transmission element 11 toward the engaged position. This allows the coupling of the driver 9 and the actuator 19 under normal use conditions, that is, in the absence of failure of the actuator 19. In this example, the transmission element 11 is acted upon axially.

When the member 8 made of shape memory material changes state and urges the transmission element 11 toward the disengaged position, for example when it expands, this is counter to the force exerted by the elastic return element 21.

In this example, the elastic return element 21 is arranged so as to act on the main body 15 of the transmission element 11.

By way of example, the elastic return element 21 can be realized in the form of a clip intended to enclose the drive shaft 70, in this case the second part 72, housed in the transmission element 11, while coming into contact with at least one surface of the transmission element 11. The elastic return element 21, for example in this clip form, thus makes it possible to link the drive shaft 70 and the transmission element 11.

The clip has a base 211 from which two tabs 213 extend in a parallel or substantially parallel manner. In the example illustrated, the tabs 213 are curved when the clip is in the rest state. When the member 8 made of shape memory material changes state and urges the transmission element 11 toward the disengaged position, the clip is compressed such that the tabs 213 extend substantially in the same plane as the base 211 of the clip.

Furthermore, regarding the cooperation of the transmission element 11 with the driver 9, the transmission element 11, in particular the main body 15, can be coupled to the driver 9 by cooperation of shapes in normal operation. According to the embodiment described, the transmission element 11 is configured to mesh with the driver 9 in normal operation. To this end, with reference to FIG. 5, the transmission element 11 has toothing complementary to the toothing of the driver 9. This toothing is provided on a face of the main body 15 arranged on the same side as the driver 9. The toothing of the transmission element 11 is configured to cooperate with the toothing of the driver 9 so as to rotationally couple the driver 9 and the transmission element 11 in the engaged position. The toothing of the transmission element 11 comprises a plurality of teeth 153 alternating with a plurality of recesses 155. The teeth 153 of the transmission element 11 are configured to interlock with the teeth 95 of the driver 9 so as to rigidly connect the transmission element 11 and the driver 9 together so that they rotate as one.

In the disengaged position of the transmission element 11, the toothing thereof is disengaged from the toothing of the driver 9.

Furthermore, the disconnection between the actuator 19 and the articulated mechanism 21 caused by the disconnection between the transmission element 11 and the driver 9 can be reversible. In other words, the driver 9 and the transmission element 11 can return to the engaged position in which they are rigidly connected for example when the failure of the actuator 19 was only temporary, in order to return to a fault-free normal operation configuration.

The member 8 made of shape memory material is thus mounted and held in an assembly that is movable about the driving axis A, with respect to the track holder which for its part is rotationally retained. This movable assembly is formed by the drive shaft 70 and the transmission element 11, more specifically by the second part 72 of the drive shaft 70, and the main body 15 and the closure cap 17 of the transmission element 11. This movable assembly is itself mounted in the driver 9, which is likewise movable.

These elements form an engagement and disengagement mechanism making it possible to couple or disconnect the transmission element 11 and the driver 9.

Failure-Free Normal Operating Mode

Thus, in a normal operating mode, that is, without any faults and without the failure of the actuator 19, the actuator 19 controls the articulated mechanism 21 so as to allow the movement of the aerodynamic regions of the deflector with respect to each other, by means, in the example illustrated in FIGS. 1 to 4, of the two rods 70 and 71.

The elastic return element 21 is in the rest state, and the member 8 made of shape memory material is not supplied with power and is compressed. The sliding contacts 87 can be arranged in contact with the tracks 101. As long as the member 8 made of shape memory material remains in the compressed state, the transmission element 11 is kept coupled to the driver 9 by virtue of the return force exerted by the elastic return element 21.

The actuator 19, under the effect of a command, drives the rotation of the drive shaft 70 rotationally coupled to the transmission element 11; as the driver 9 is rigidly connected to the transmission element 11, it takes on the same rotating movement.

The driver 9 drives the rod 70 in translation with respect to the retraction axis by means of the toothed main body 27 of the drive 9. The movement of the rod 70 is transmitted to the adjacent rod 71 by means of the pinions 80 meshing together, while the sheaths 90 cooperate with the movement rail 69 of the slider 22. The slider 22 then moves in a translational movement with respect to the platform 33 of the articulated mechanism 21, parallel to the retraction axis 20.

Operating Mode if the Actuator Fails

If the actuator 19 fails, for example when the actuator 19 is no longer supplied with power as a result of a short circuit or the wiring harness being cut or as a result of the electric drive not operating, or in the case of internal breakage of an element of the actuator 19, the actuator 19 is disconnected from the articulated mechanism 21, and more specifically, the actuator 19 is disconnected from the drive shaft 70.

More specifically, the member 8 made of shape memory material can be supplied with electric power by means of the conductive tracks 101 of the track holder 10, and deforms between the first state and the second state, that is, in the example described, it can expand or lengthen by a sufficient distance to decouple the transmission element 11 and the driver 9. Upon expanding, the member 8 made of shape memory material acts on the transmission element 11, which moves toward the disengaged position and thus disconnects from the driver 9. In this example, the teeth provided on the transmission element 11 and the driver 9, respectively, are disengaged from one another.

In addition, referring again to FIG. 7, while the expansion of the member 8 made of shape memory material continues, the plates 88 move toward the track holder 10, advantageously until, at the end of travel of the member 8 made of shape memory material, the ends 872 come away from the tracks 101 and come into mechanical contact with the non-conductive track 101′, without electrical contact. The sliding contacts 87 coming away from the tracks 101 then stops the electric power supply to the member 8 made of shape memory material. Thus, the sliding contacts 87 are only supplied with electric power for the minimum time necessary to disconnect the driver 9 and the transmission element 11, that is, long enough for the toothing of the transmission element 11 to disengage from the toothing of the driver 9.

The driver 9 is disconnected from the transmission element, which is itself coupled to the drive shaft 70, which is rigidly connected to the actuator 19.

The driver 9, once disconnected from the actuator 19, is then free to rotate again. If the actuator 19 fails, and when the deflector device 7 is in the deployed position, it can be returned to the retracted position in a variety of manners. By way of example, return means can be provided such as a return spring 500, arranged so as to exert a return force on at least one of the aerodynamic regions 7 in order to keep said deflector in the deployed position when the actuator 19 is operating normally, and such that if the actuator 19 malfunctions, the aerodynamic regions move with respect to each other so as to return the deflector device 7 to the retracted position.

When the actuator 19 is disconnected from the articulated mechanism 21, the tracks 101 are no longer supplied with power. For its part, on cooling, the member 8 made of shape memory material returns to the compressed state.

As long as the actuator 19 does not transmit a rotational movement to the drive shaft 70 again, the driver 9 remains in the open position.

If the actuator 19 comes back into operation, provision can be made for the transmission element 11 to be able to rigidly connect to the driver 9 again. The safety device 50 could then be repositioned in its initial configuration.

The device according to the present invention therefore has the advantage, in a situation in which the actuator 19 has failed, of making it possible to return to a configuration in which the deflector device is in the retracted position (FIG. 2) without any need for external intervention.

1. A deflector device for a motor vehicle wheel comprising:
at least one aerodynamic region, arranged so that it is exposed to a flow of external air;
an articulated mechanism for moving said at least one aerodynamic region, so as to allow the deflector to pass from a retracted position to a deployed position, the articulated mechanism having a drive member, and the articulated mechanism being arranged to move the drive member in a translational movement when the deflector device passes from the retracted position to the deployed position;
an actuator, configured to control the articulated mechanism, so as to allow the movement of the aerodynamic regions of the deflector with respect to each other; and
a safety device configured to return said deflector device to the retracted position without the intervention of the actuator.

2. The deflector device as claimed in claim 1, in which said safety device is configured to disconnect said actuator from the articulated mechanism in the event of a fault, such as the failure of the actuator or emergency braking.

3. The deflector device as claimed in claim 1, the articulated mechanism including a platform arranged so that it is fixed with respect to the vehicle, said platform being mounted on the vehicle, and the drive member moving in a translational movement with respect to said platform.

4. The deflector device as claimed in claim 3, the drive member and the platform of the articulated mechanism being connected by means of at least two rods moving with respect to each other.

5. The deflector device as claimed in claim 4, the drive member being a slider provided with at least one movement rail.

6. The deflector device as claimed in claim 6, in which each of the rods is provided with a toothed wheel at the end thereof connected to the platform of the articulated mechanism, said toothed wheels meshing together, and in which each of the rods comprises at least one sheath at the end thereof connected to the slider of the articulated mechanism, said sheath cooperating with the movement rail of the slider, so that one of the rods, when it is driven by the actuator, transmits its movement to the adjacent rod.

7. The deflector device as claimed in claim 1, in which said safety device comprises:
at least one member made of a shape memory material, configured to be supplied with electric power so as to deform between a first state and a second state in order to disconnect the actuator from the articulated mechanism,
in the event of a fault, such as the failure of the actuator or emergency braking, the safety device having a track holder having at least two conductive tracks for supplying said at least one member made of a shape memory material with electric power, and
said at least one member made of a shape memory material having at least two contactor elements configured to each be arranged in electrical contact with an associated conductive track, at least when said at least one member made of shape memory material is in the first state.

8. The deflector device as claimed in claim 7, in which:
the holder has an annular overall shape that is centered on the driving axis and has a predefined radial footprint, and
said at least two contactor elements are arranged so that they have a radial footprint smaller than or around the same as the radial footprint of the track holder.

9. The deflector device as claimed in claim 7, in which the safety device comprises a drive shaft configured to be arranged so as to transmit a movement from the actuator to said articulated mechanism, the drive shaft having a cavity for receiving said at least one member made of shape memory material.

10. A motor vehicle comprising:
at least one aerodynamic deflector device arranged upstream of a vehicle wheel, the deflector device comprising:
at least one aerodynamic region that is exposed to a flow of external air,
an articulated mechanism for moving said at least one aerodynamic region, to allow the deflector to pass from a retracted position to a deployed position, the articulated mechanism having a drive member,
the articulated mechanism being arranged to move the drive member in a translational movement when the deflector device passes from the retracted position to the deployed position,
an actuator configured to control the articulated mechanism to allow the movement of the aerodynamic region of the deflector, and
a safety device configured to return said deflector device to the retracted position without the intervention of the actuator.
